(19) United States
(12) Patent Application Publication
(10) Pub. No.: US 2026/0104733 A1
(43) Pub. Date: Apr. 16, 2026

(54) SCREEN PROTECTOR APPLICATOR AND COMPUTING DEVICE CASE

(71) Applicant: CTB Holdings LLC, Portola Valley, CA (US)

(72) Inventors: Thuan Tran, San Jose, CA (US); Charlie Carroll, Palo Alto, CA (US); Binh Tran, Santa Clara, CA (US)

(21) Appl. No.: 19/420,734

(22) Filed: Dec. 16, 2025

Related U.S. Application Data
(63) Continuation of application No. 19/046,818, filed on Feb. 6, 2025.
(60) Provisional application No. 63/709,033, filed on Oct. 18, 2024.
(60) Provisional application No. 63/660,431, filed on Jun. 14, 2024.

(51) Int. Cl. G06F 1/16; H04M 1/02

(52) U.S. Cl. CPC G06F 1/1629; H04M 1/0203; G06F 2200/1634

(57) ABSTRACT

Included in the present disclosure is a system, including a screen protector configured to be applied to a first side of a computing device. In some embodiments, the system includes a case configured to be coupled to the computing device in two arrangements. According to some embodiments, in a first arrangement the case is configured to be disposed over the first side of the computing device such that the screen protector is located between an inner surface of the case and the first side of the computing device, the case configured to align the screen protector with at least a portion of a perimeter of the first side of the computing device. In a second arrangement, the case may be configured to be disposed over a second side of the computing device opposite the first side of the computing device.

### CROSS-REFERENCE TO RELATED APPLICATIONS

The entire contents of the following application are incorporated by reference herein: U.S. Provisional Patent Application No. 19/046,818; filed February 6, 2025; and entitled SCREEN PROTECTOR APPLICATOR AND COMPUTING DEVICE CASE.

The entire contents of the following application are incorporated by reference herein: U.S. Provisional Patent Application No. 63/660,431; filed June 14, 2024; and entitled SCREEN PROTECTION PLACEMENT DEVICE AND METHODS OF USE.

The entire contents of the following application are incorporated by reference herein: U.S. Provisional Patent Application No. 63/709,033; filed October 18, 2024; and entitled SCREEN PROTECTOR APPLICATOR AND COMPUTING DEVICE CASE.

### Technical Field

The present disclosure relates to cases for computing devices and screen protectors.

### BACKGROUND

A screen protector may act as a sacrificial layer, absorbing the wear and tear that would otherwise affect a computing device's screen. By providing an additional barrier, screen protectors help preserve the pristine condition of the screen, prolonging its lifespan and maintaining its visibility and touch sensitivity.

Installing a screen protector may be difficult and time-consuming, potentially resulting in misalignment, air bubbles, and other problems with the screen protector.

### SUMMARY

The foregoing, and other features and advantages of the invention, will be apparent from the following, more particular description of the preferred embodiments of the invention, the accompanying drawings, and the claims.

Included in the present disclosure is a system, including a screen protector (e.g., the screen protector 102 as seen in FIG. 1) configured to be applied to a first side (e.g., the first side 1902 as seen in FIG. 19) of a computing device (e.g., the computing device 40 as seen in FIG. 1). In some embodiments, the system includes a case (e.g., the interior case 20 as seen in FIG. 1) configured to be coupled to the computing device in two arrangements. According to some embodiments, in a first arrangement, the case is configured to be disposed over the first side of the computing device such that the screen protector is located between an inner surface (e.g., the inner surface 1406 as seen in FIG. 14) of the case and the first side of the computing device, the case configured to align the screen protector with at least a portion of a perimeter (e.g., the perimeter 1604 as seen in FIG. 16) of the first side of the computing device. In a second arrangement, the case may be configured to be disposed over a second side (e.g., the second side 1602 as seen in FIG. 16) of the computing device opposite the first side of the computing device.

In some embodiments, in the first arrangement, the case is configured to enable the screen protector to adhere to the first side of the computing device. According to some embodiments, the system further includes a dust removal film (e.g., the dust removal film 104 as seen in FIG. 17) coupled to a surface of the screen protector. The system may further include a pull tab (e.g., the pull tab 106 as seen in FIG. 16) coupled to the dust removal film configured to remove the dust removal film and thereby enable the screen protector to adhere to the first side of the computing device.

In some embodiments, a surface perimeter of the screen protector is configured to align with the perimeter of the first side of the computing device.

According to some embodiments, the case includes a side wall (e.g., the side wall 1502 as seen in FIG. 15) extending from the inner surface of the case. The side wall may include a protruding portion (e.g., protruding portions 204 as seen in FIG. 3) to removably affix the case to the computing device in an arrangement selected from the group consisting of the first arrangement, the second arrangement, and combinations thereof. In some embodiments, the side wall may include an opening (e.g., the side wall opening 1504 as seen in FIG. 15) sized to pass the screen protector therethrough.

According to some embodiments, an outer side of the case is configured to receive a pressure through an external source and thereby contact the screen protector when in the first arrangement, thereby applying the pressure to the screen protector. The pressure may be configured to remove an air bubble (e.g., the air bubble 50 as seen in FIG. 7) from between the screen protector and the first side of the computing device.

In some embodiments, the case is an interior case, the system further including an exterior case (e.g., the exterior case 30 as seen in FIG. 8) configured to couple to the interior case in the second arrangement. According to some embodiments, the interior case includes an opening (e.g., the openings 1402, as seen in FIG. 14), and the exterior case includes a protrusion (e.g., the protrusions 1102 as seen in FIG. 11) that aligns with the opening, the protrusion facing the interior case. The exterior case may include an indentation (e.g., the indentations 1204 as seen in FIG. 12) that aligns with the protrusion, the indentation located on an opposite side of the exterior case from the protrusion.

Also included in the present disclosure is a method, including coupling a case and a screen protector to a first side of a computing device (e.g., step 2302 as seen in FIG. 23) such that the screen protector is disposed between the case and the first side of the computing device. In some embodiments, the method includes affixing the screen protector to the first side of the computing device (e.g., step 2304 as seen in FIG. 23). According to some embodiments, the method includes removing the case from the first side of the computing device (e.g., step 2306 as seen in FIG. 23). The method may include coupling the case to a second side of the computing device opposite the first side of the computing device (e.g., step 2308 as seen in FIG. 23).

In some embodiments, coupling the case and the screen protector to the first side of the computing device includes aligning the screen protector with at least a portion of a perimeter of the first side of the computing device (e.g., step 2402 as seen in FIG. 24). According to some embodiments, affixing the screen protector to the first side of the computing device includes removing a dust removal film from the screen protector (e.g., step 2406 as seen in FIG. 24). Removing the dust removal film from the screen protector may include pulling on a pull tab coupled to the dust removal film (e.g., step 2408 as seen in FIG. 24).

In some embodiments, the method further includes applying pressure to the screen protector (e.g., step 2410 as seen in FIG. 24). According to some embodiments, applying pressure to the screen protector is configured to remove an air bubble between the screen protector and the first side of the computing device.

The case may be an interior case, and the method may further include coupling an exterior case to the second side of the computing device (e.g., step 2502 as seen in FIG. 25) such that the interior case is located between the exterior case and the second side of the computing device.

### BRIEF DESCRIPTION OF THE DRAWINGS

These and other features, aspects, and advantages are described below with reference to the drawings, which are intended to illustrate, but not to limit, the invention. In the drawings, like characters denote corresponding features consistently throughout similar embodiments.

FIG. 1 illustrates an exploded perspective view of a screen protector placement and case system, according to some embodiments.

FIG. 2 illustrates a bottom perspective view of a screen protection placement device, according to some embodiments.

FIG. 3 illustrates a bottom perspective view of the screen protection placement device, according to some embodiments.

FIG. 4 illustrates a top perspective view of the screen protection placement device, according to some embodiments.

FIG. 5 illustrates a top perspective view of the screen protection placement device, according to some embodiments.

FIG. 6 illustrates a top perspective view of the screen protection placement device, according to some embodiments.

FIG. 7 illustrates a top perspective view of a computing device, according to some embodiments.

FIG. 8 illustrates a top perspective view of a computing device, according to some embodiments.

FIG. 9 illustrates a front right perspective view of a screen protector placement and case system, according to some embodiments.

FIG. 10 illustrates a back left perspective view of a screen protector placement and case system, according to some embodiments.

FIG. 11 illustrates a back view of a screen protector placement and case system, according to some embodiments.

FIG. 12 illustrates a front view of an exterior case, according to some embodiments.

FIG. 13 illustrates a back left perspective view of an exterior case, according to some embodiments.

FIG. 14 illustrates a back left perspective view of an interior case, according to some embodiments.

FIG. 15 illustrates a bottom front perspective view of an interior case, according to some embodiments.

FIG. 16 illustrates an exploded perspective view of a screen protector and a case being placed onto a computing device, according to some embodiments.

FIG. 17 illustrates a profile view of a dust removal film being removed from a case, according to some embodiments.

FIG. 18 illustrates a profile view of a pressure being exerted on a case and a dust removal film separated from the screen protector, according to some embodiments.

FIG. 19 illustrates a case being removed from a computing device, according to some embodiments.

FIG. 20 illustrates a case being placed onto another side of a computing device, according to some embodiments.

FIG. 21 illustrates a second case being placed onto a computing device, according to some embodiments.

FIG. 22 illustrates a computing device with multiple cases placed onto it, according to some embodiments.

FIG. 23 illustrates a flow chart depicting a method of coupling a case and a screen protector to a computing device, according to some embodiments.

FIG. 24 illustrates a flow chart depicting a method of aligning and adhering a screen protector to a computing device, according to some embodiments.

FIG. 25 illustrates a method coupling an additional case to a computing device including one case, according to some embodiments.

FIG. 26 illustrates a method of replacing a screen protector, according to some embodiments.

### DETAILED DESCRIPTION

Screen protectors come in various types and designs to cater to different devices and user preferences. Some are specifically tailored to fit particular models, while others are more generic and may trimmed to size. They may also vary in thickness, clarity, and additional features such as anti-glare or privacy filters.

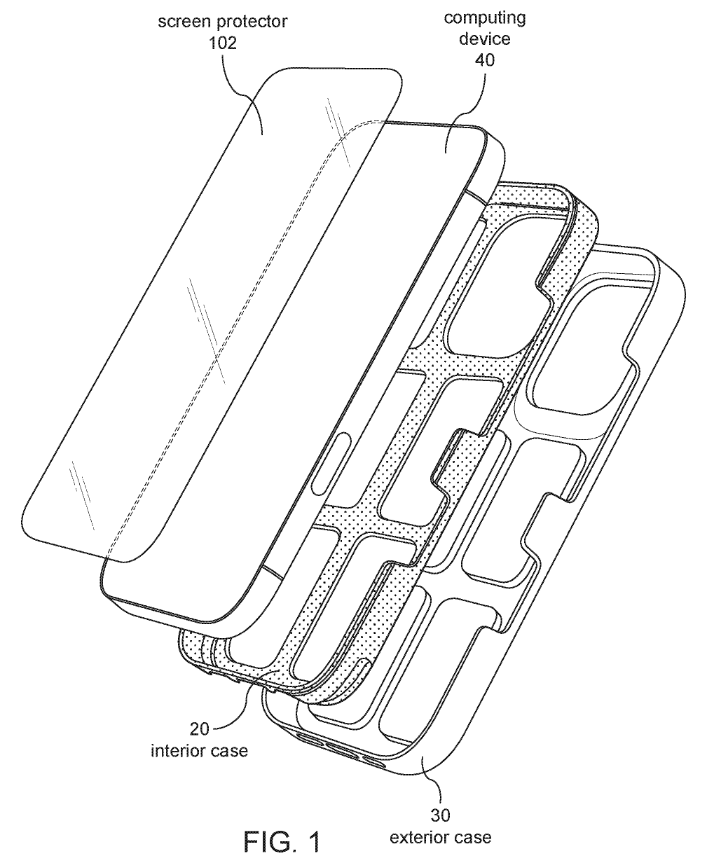

Disclosed herein, in some aspects, are systems, methods, and/or kits relating to a protective assembly for a computing device. FIG. 1 provides an exemplary depiction of a protective assembly for a computing device, according to some embodiments described herein. In some embodiments, the protective assembly includes a screen protector 102 and an interior case 20. The screen protector 102 may be configured to be applied to a first side of the computing device 40, thereby providing protection to the first side, while the interior case 20 may be configured to be coupled to the computing device 40 in two arrangements. In a first arrangement, the interior case 20 may be configured to couple to the first side of the computing device 40, such as, for example, the interior case 20 being configured to be disposed on and/or over the first side of the computing device 40. In a second arrangement, the interior case 20 may be configured to be coupled to a second side of the computing device 40, specifically disposed on and/or over the second side so as to provide protection to at least a portion of the second side, at least a portion of the side surfaces, and/or at least a portion of the first side of the computing device 40.

The interior case 20, while in the first arrangement, may be further configured to enable alignment of the screen protector 102 about the first side of the computing device 40. For example, an outer perimeter of the screen protector 102 may be aligned, via the interior case 20, to correspond with a perimeter of the first side of the computing device 40. The interior case 20, while in the first arrangement, may also be configured to enable adhesion and/or other affixation of the screen protector 102 to the first side of the computing device 40. The screen protector may be a thin, transparent sheet of material that may be configured to protect a surface (e.g., screen) of the computing device from scratches, smudges, and other damage. The screen protector may be made from materials like tempered glass or polyurethane film.

In some embodiments, the protective assembly further includes an exterior case 30 configured to be coupled to the interior case 20. For example, the exterior case 30 may be configured to be disposed on and/or over the interior case 20. Accordingly, the exterior case 30 may be coupled to the interior case 20 when said interior case 20 is coupled to the computing device 40 in the second arrangement, such that the exterior case 30 provides additional protection to the second side of the computing device 40.

### SCREEN PROTECTOR ALIGNMENT AND PLACEMENT

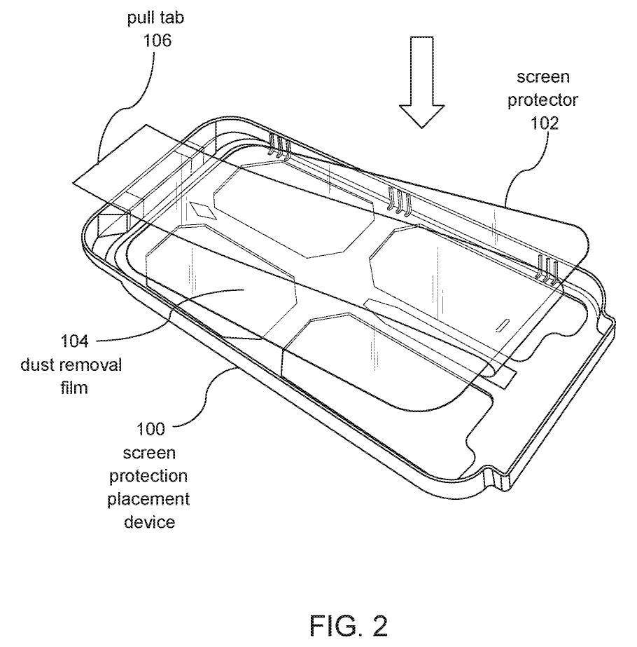

FIGS. 2-8 illustrate an exemplary embodiment of a screen protector placement kit for applying a screen protector onto a computing device, such as onto a screen of the computing device, which may correspond to a first side of the computing device. The screen protector placement kit may include the screen protector 102 and a screen protection placement device 100. In some embodiments, the interior case 20 (see for example FIG. 1 and FIGS. 14-21), as described herein, may be used in place of the screen protection placement device 100, and/or in the same manner as the screen protection placement device 100, as described herein with reference to FIGS. 2-8.

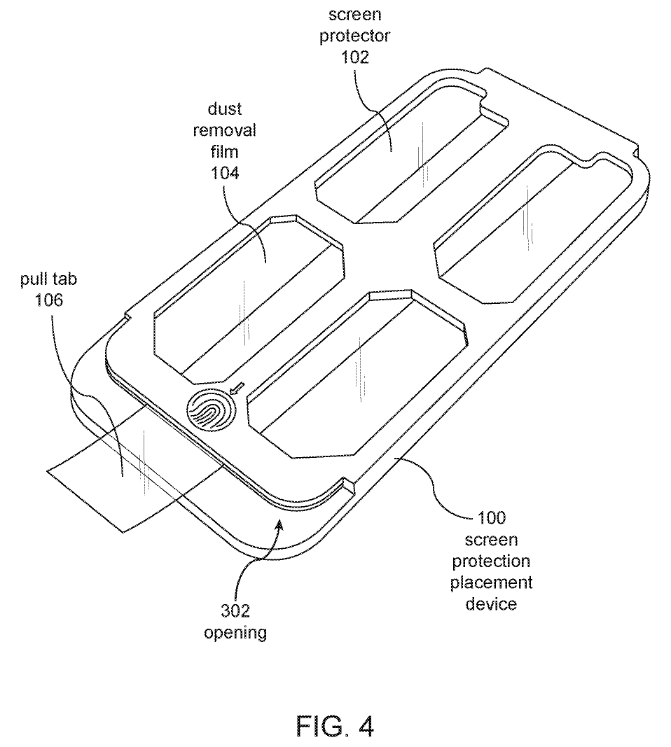

FIG. 2 illustrates a bottom perspective view of a screen protection placement device 100, according to some embodiments, wherein a screen protector 102 is being placed at least partially within the screen protection placement device 100. For example, the screen protection placement device 100 may include a i) back portion, having an outer surface 404 (see FIGS. 4-6) and an inner surface 208 (see FIGS. 1-2), and ii) one or more side walls 206 extending from the back portion. Accordingly, the screen protector 102 may be placed within an interior space within the screen protection placement device 100, the interior space being defined by inner surface 208 and the side walls 206, wherein the screen protector 102 may be disposed across and/or may couple with the inner surface 208 of the screen protection placement device 100. FIG. 1 illustrates the screen protection placement device 100 as sized and shaped for a mobile phone. In other embodiments, the screen protection placement device 100 may be sized and/or shaped for the application of the screen protector 102 on other types of computing devices, such as tablets, laptops, smartwatches, etc.

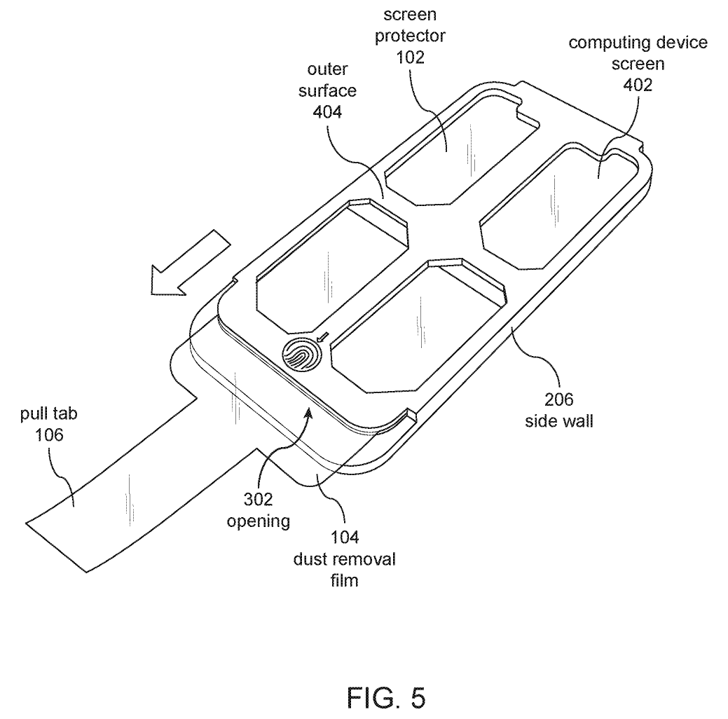

In some embodiments, the screen protector 102 is removably coupled with a dust removal film 104 (see. FIG. 5 for example). For example, the dust removal film 104 may be removably adhered to, removably affixed to, or otherwise removably attached to the screen protector 102. According to some embodiments, when the screen protector 102 is placed within the screen protection placement device 100 (as described herein), the dust removal film 104 may be located on a side of the screen protector 102 opposite the side of the screen protector 102 that is facing and/or adjacent to the inner surface 208 of the screen protection placement device 100. Alternatively, the dust removal film 104 may be located on the side of the screen protector 102 that is facing and/or adjacent to the inner surface 208 of the screen protection placement device 100, when the screen protector 102 is inserted within the screen protection placement device 100 (as described herein).

The dust removal film 104 may be the same size and/or shape as the screen protector 102. In some embodiments, the dust removal film 104 covers an entire side of the screen protector 102. In some embodiments, the dust removal film 104 may prevent fingerprints or other debris from being placed on the screen protector from the outside before and during placement of the screen protector. In the case of the dust removal film facing the first surface of the computing device, the dust removal film may prevent any particulate from forming along any adhesive or other surface on the screen protector prior to affixing the screen protector to the first surface of the computing device. In such instances, the dust removal film may further include a material or tackiness in order to pick up any preexisting debris or adhesive, such as that from a previous screen protector that has been removed.

In some embodiments, the dust removal film 104 is coupled to a pull tab 106. The pull tab 106 may extend from the dust removal film 104. The dust removal film 104 may be disposed on a first side of the screen protector 102, wherein the pull tab 106 extends from one end of the dust removal film 104, wraps around the screen protector 102, and extends along and/or across a second side (longitudinal or lateral) of the screen protector 102 opposite the first side. In other embodiments, the pull tab 106 extends along and/or across (longitudinal or lateral) the dust removal film 104 when coupled to the screen protector 102. The pull tab 106 may vary in length, such as being longer than a length of the screen protector 102, being about the same length of the screen protector 102, or less than a length of the screen protector 102.

In additional embodiments, the screen protector 102 has two dust removal films – a dust removal film 104 disposed on a first side of the screen protector 102, as well as a dust removal film (not shown) disposed on a second side of the screen protector 102.

The dust removal film 104 disposed on the first side of the screen protector 102 may face toward a computing device onto which the screen protector 102 is being placed. This dust removal film 104 may include a pull tab 106 that extends from a “top” side of the dust removal film 104 and extends back upon the dust removal film 104, elongated such that the pull tab 106 extends past a “bottom” of the dust removal film 104.

Once the screen protector 102 has been placed on the computing device (within the screen protection placement device 100), the pull tab 106 may be pulled through a slot in the screen protection placement device 100 in order to remove this dust removal film 104 and begin adhesion of the screen protector 102 to the computing device (see for example, FIG. 5).

The dust removal film (not shown) disposed on the second side of the screen protector 102 may face away from the computing device onto which the screen protector 102 is being placed. This dust removal film may act as a protective device to prevent abrasions from occurring on the screen protector 102 prior to placement on the computing device. This dust removal film may be removed prior to inserting the screen protector 102 into the screen protector placement device 100.

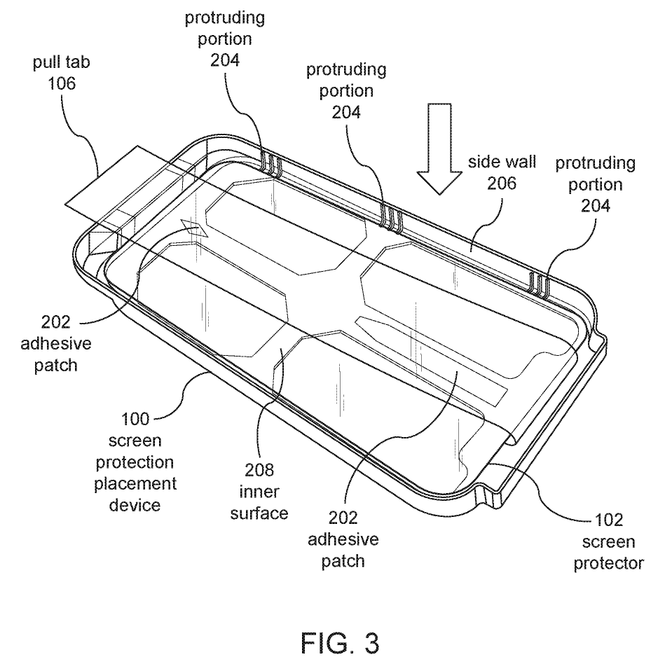

FIG. 3 illustrates a bottom perspective view of the screen protection placement device 100, according to some embodiments. This figure shows the screen protector 102 placed at least partially within the screen protection placement device 100, or more specifically, within a space defined by the side walls 206 and an inner surface 208 of the screen protection placement device 100. In some embodiments, the screen protection placement device 100 includes one or more adhesive patches 202. The one or more adhesive patches may be disposed on the inner surface of the screen protection placement device 100. The one or more adhesive patches 202 may allow the screen protector 102 to adhere to the screen protection placement device 100 such that the screen protector 102 stays in place during application to the computing device (e.g., a first side of the computing device, which may be a screen).

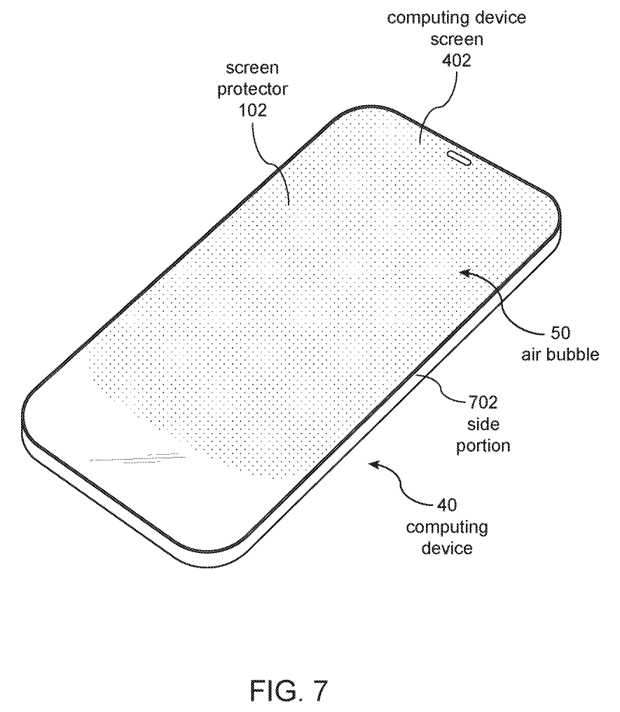

According to some embodiments, a computing device 40 may be disposed over the screen protector 102 that is already placed within (as described herein) the screen protection placement device 100. The computing device 40 may have dimensions aligning with the interior space defined by the side walls 206 of the computing device 40. For example, the computing device 40 may include one or more side portions (such as side portion 702 as seen in FIG. 7 below) that correspond to the one or more side walls 206 of the screen protection placement device 100. Accordingly, the inner surface 208 and side walls 206 of the screen protection placement device 100 help position the screen protector 102 with respect to a first side of the computing device, that is also aligned by the inner surface 208 and side walls 206 of the screen protection placement device 100.

The screen protection placement device 100 may also include one or more protruding portions 204. The one or more protruding portions 204 may be are located along a side wall 206 of the screen protection placement device 100. The one or more protruding portions 204 may be configured to couple with a computing device inserted at least partially within (as described herein) the screen protection placement device 100, so as to help hold said computing device 40 at least partially within the screen protection placement device 100, such that the computing device stays in place or substantially stays in place during application of the screen protector 102 to the computing device (e.g., a screen or first side of the computing device).

FIG. 4 illustrates a top perspective view of the screen protection placement device 100, according to some embodiments. This figure shows the screen protection placement device 100 with the screen protector 102 in place against an interior of the screen protection placement device 100, and on an opposite side to an outer surface 404 of the screen protection placement device 100 (for example, the screen protector 102 is placed within the screen protection placement device 100, as described herein). FIG. 4 additionally illustrates the pull tab 106 extending through an opening 302 in the screen protection placement device 100. In some examples, the opening 302 is sized and configured such that the dust removal film 104 and/or screen protector 102 may be passed therethrough. Accordingly, the dust removal film 104 may be removed from the interior of the screen protection placement device 100 through the opening 302.

FIG. 5 illustrates a top perspective view of the screen protection placement device 100, according to some embodiments. This figure shows the screen protection placement device 100 disposed over a first side of a computing device (e.g., mobile phone screen) 402. FIG. 5 is similar to FIG. 4, although FIG. 5 illustrates the dust removal film 104 being pulled through the opening 302 of the screen protection placement device 100. In some embodiments, the dust removal film 104 is pulled through the opening 302 via the pull tab 106. According to some embodiments, the dust removal film 104 is pulled from between the screen protector 102 and the first side of the computing device (e.g., mobile phone screen 402). In other embodiments, the dust removal film 104 is pulled from between the screen protector 102 and the inner surface 208 of the screen protection placement device 100. In yet other embodiments, the dust removal film is pulled from between the screen protector 102 and the first side of the computing device 40, but wraps around the screen protector 102, and is then pulled between the screen protector 102 and the inner surface 208 of the screen protection placement device 100. The dust removal film 104 may wrap around an end of the screen protector 102 that is disposed about an end of the screen protection placement device 100 opposite to the end where the opening 302 is located.

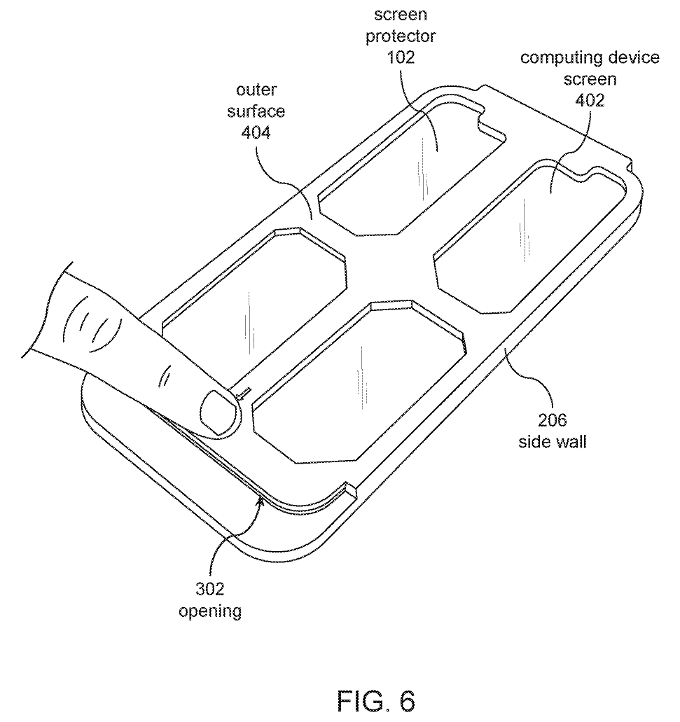

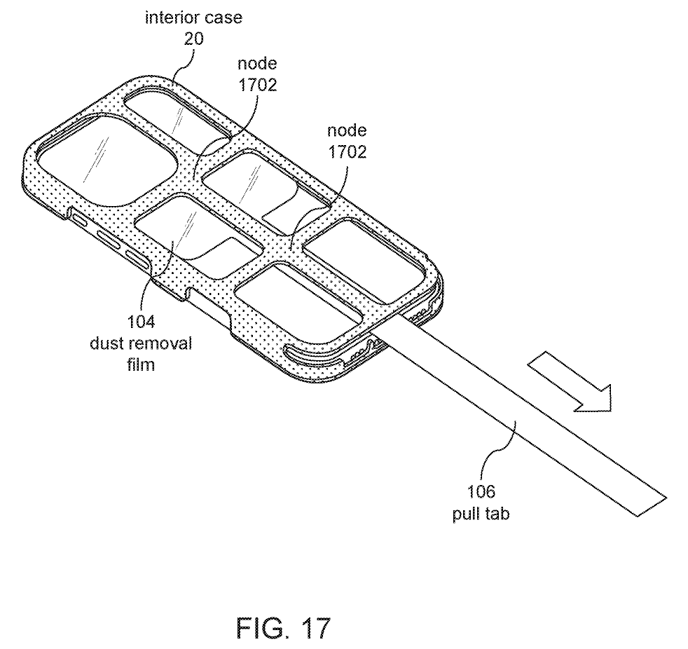

FIG. 6 illustrates a top perspective view of the screen protection placement device 100, according to some embodiments. This figure shows a user’s press of the outer surface 404 of the screen protection placement device 100, near the opening 302 from which the dust removal film 104 was pulled out of the screen protection placement device 100. The user press may be at any portion of the outer surface 404 of the screen protection placement device 100. Moreover, the screen protection placement device 100 may include any form of an outer surface, such as a solid continuous surface, any number of grids having any number of nodes (see nodes 1702 in FIG. 17 below for example), an outer surface having one or more curves or other shapes, etc.

In some embodiments, the user’s press on the outer surface 404 applies a pressure, which may thereby apply a pressure to the screen protector 102 towards the computing device. Applying a pressure on the outer surface 404 may help adhere the screen protector 102 to the mobile phone screen 402. Alternatively, or additionally, applying a pressure on the outer surface may help remove and/or reduce the presence of air bubbles 50 (see FIG. 7 for example) disposed between the screen protector and the first side of the computing device (e.g., screen). In one example, a user may slide a finger or other object along the outer surface 404 of the screen protection placement device 100 so as to help the screen protector 102 adhere to the computing device, and/or reduce the presence of air bubbles located therebetween.

FIG. 7 illustrates a top perspective view of a computing device 40 (e.g., mobile phone), according to some embodiments. This figure shows the screen protector 102 partially adhered to the mobile phone screen 402. In some embodiments, the adhered portion of the screen protector 102 is near the end of the screen protector 102 where, for example, if the user only pressed and applied pressure to the screen protection placement device 100 about this location, as depicted in FIG. 6. FIG. 7 additionally illustrates the portion of the screen protector 102 that is not adhered to the mobile phone screen 402. The portion of the screen protector 102 that is not adhered to the screen may be due to an air bubble between the screen protector 102 and the computing device (e.g., mobile phone screen 402).

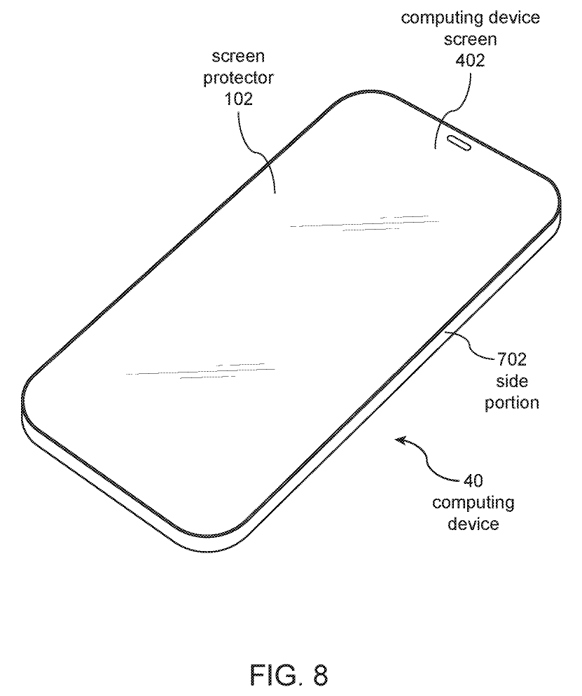

FIG. 8 illustrates a top perspective view of a computing device, according to some embodiments. This figure is similar to FIG. 7, although FIG. 8 shows the screen protector 102 fully adhered to the first side of a computing device (e.g., mobile phone screen 402). As described herein, the first side of the computing device may include a mobile phone screen, and/or other types of screens, such as a tablet screen. As illustrated, an air bubble may be removed between the screen protector 102 and the first side of a computing device (e.g., mobile phone screen 402).

While not specifically outlined, FIGS. 2-8 may represent the steps of using the screen protection placement device 100 to place a screen protector 102 on a screen.

### SCREEN PROTECTOR PLACEMENT AND CASE SYSTEM EMBODIMENT

In various embodiments of the forthwith figures, an interior case 20 and an exterior case 30 are shown (as also shown and described in FIG. 1 above). In many embodiments, the exterior case 30 may not be used in conjunction with the interior case 20, thus causing the interior case 20 to be the only present case. The forthcoming illustrations may also operate in such a manner as to have a single case – the interior case 20 – operating in unison without an exterior case 30.

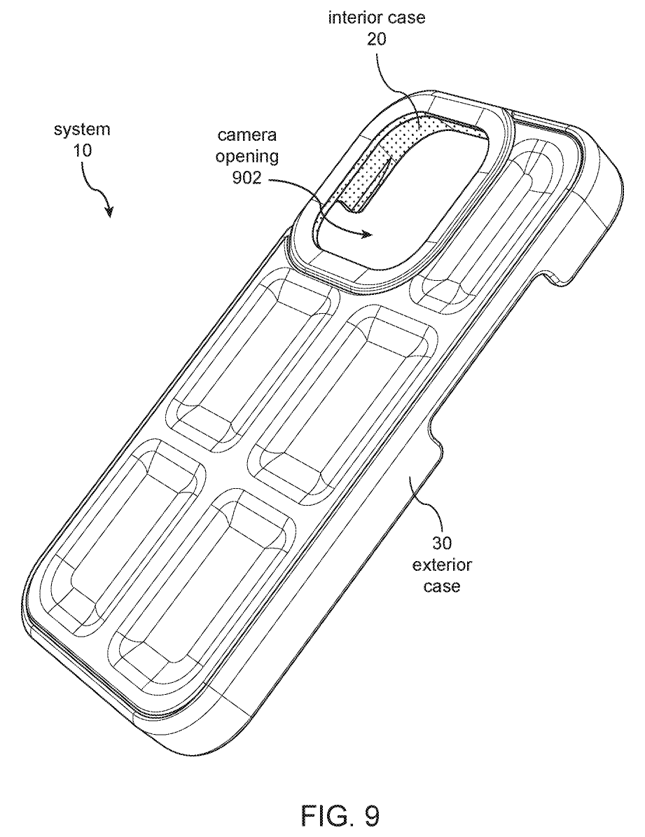

FIG. 9 illustrates a front right perspective view of a screen protector placement and case system 10, according to some embodiments. As shown, interior case 20 may be placed within an exterior case 30. Or, stated another way, an exterior case 30 may be placed about an interior case 20. The interior case 20 and the exterior case 30 may be coupled, or detachably coupled, to one another. An opening in each of the interior case 20 and the exterior case 30 may align with one another in order to form a singular opening. Such singular opening may correspond to a component, such as a camera of a computing device, to be visible and interactable with an exterior of the system 10 see, for example, camera opening 902 in instances where the component happens to be a camera, such as on a mobile phone).

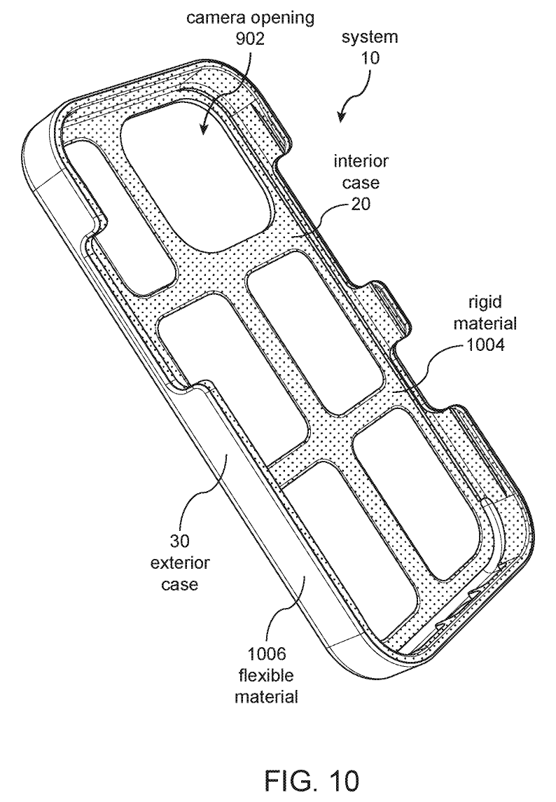

FIG. 10 illustrates a back left perspective view of a screen protector placement and case system 10, according to some embodiments. In this view, the interior case 20 may be seen nestled within the exterior case 30, and the camera opening 902 as referred to in FIG. 9 above is also shown. The interior case 20 may be made of a rigid material 1004, while the exterior case 30 may be made of a flexible material 1006. In either case, the rigid material 1004 and the flexible material 1006 may include shock-absorbing properties to prevent or limit damage occurring to any present computing device within the system 10. Additionally, the choice of materials may be flipped, or identical to one another. The flexible material 1006 may be ergonomic in shape and/or be pleasant to tactile sensation.

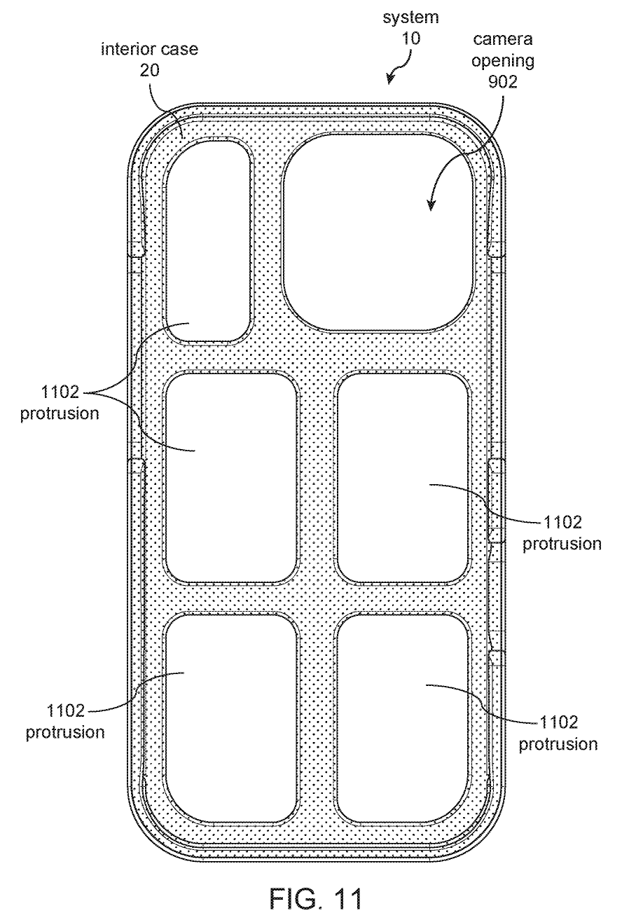

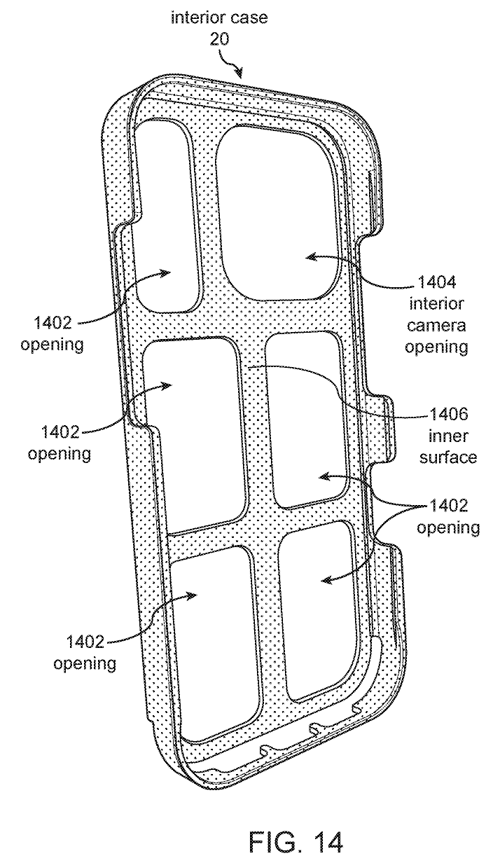

FIG. 11 illustrates a back view of a screen protector placement and case system 10, according to some embodiments. From this back view, the camera opening 902 is still shown. Protrusions 1102 are also seen. These protrusions 1102 may be a part of the exterior case 30, extending through openings (as shown and described in FIG. 14 below) of the interior case 20. In such a manner, the exterior case 30 may be coupled to the interior case 20.

Five protrusions 1102 are illustrated in FIG. 11. In alternate embodiments, any number of protrusions 1102 may be present in the exterior case 30, from as few as zero protrusions to as many protrusions as may reasonably fit on the exterior case 30. In some embodiments, it may be desirable to match the number of protrusions 1102 of the exterior case 30 to the number of openings of the interior case 20.

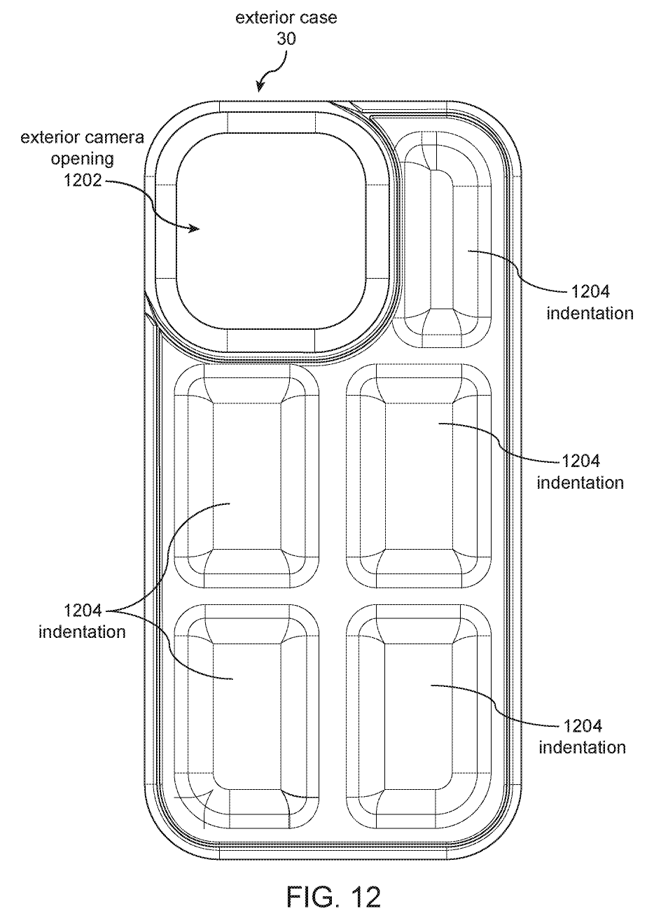

FIG. 12 illustrates a front view of an exterior case, according to some embodiments. From this view, the opening for a component, such as a camera of the computing device, may be seen specifically with respect to the exterior case 30 – otherwise called the exterior camera opening 1202. Also seen in FIG. 12 are indentations 1204. These indentations may match, in size and number, to the number of protrusions 1102 of the exterior case 30. In such a way, machining the exterior case 30 may take less material.

Five indentations 1204 are illustrated in FIG. 12, in this case matching the number of protrusions 1102 as seen in FIG. 11. In alternate embodiments, any number of indentations 1204 may be present in the exterior case 30, from as few as zero indentations to as many indentations as may reasonably fit on the exterior case 30. In some embodiments, such as the one shown in FIG. 12, it may be desirable to match the number of indentations 1204 to the number of protrusions 1102 of the exterior case 30. However, in alternate embodiments, it may be desirable to place, in location and number, protrusions based on ergonomics or tactile pleasantness of a user.

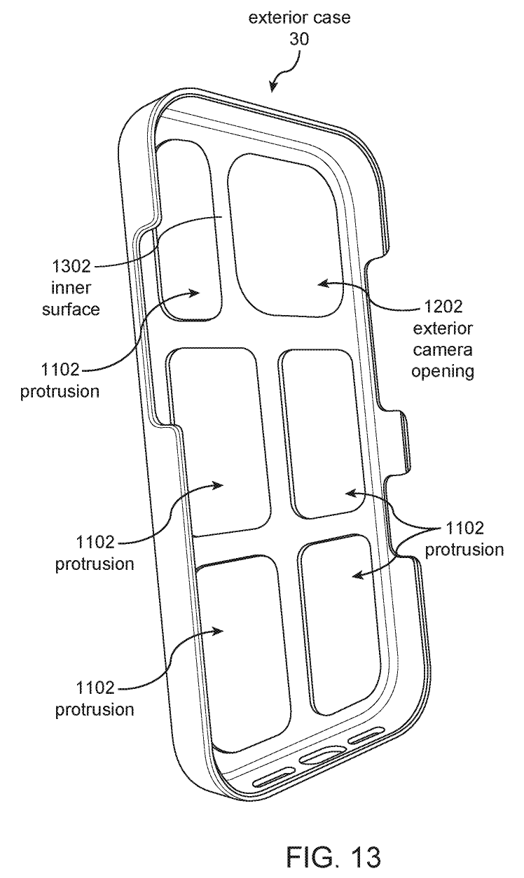

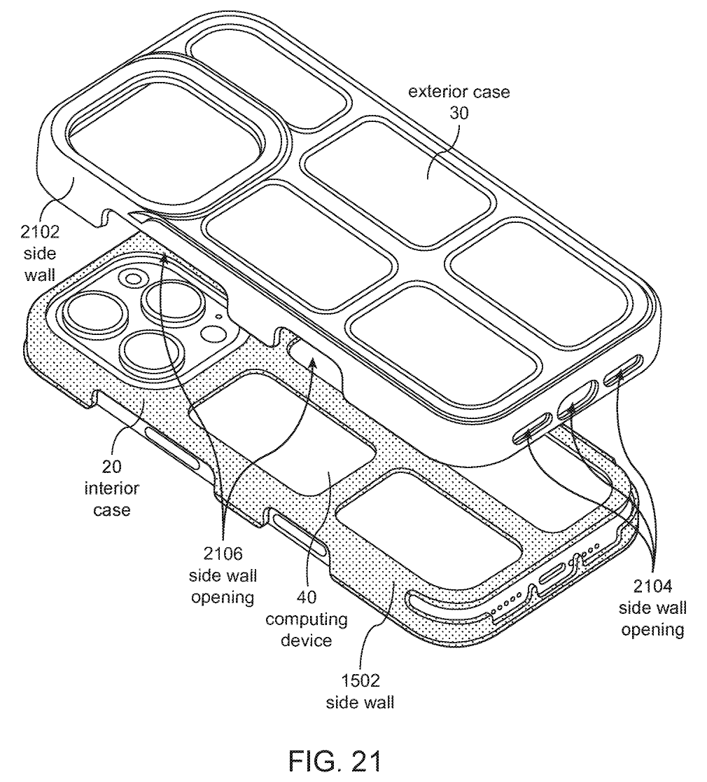

FIG. 13 illustrates a back left perspective view of an exterior case 30, according to some embodiments. From this view, a possible size/thickness of the protrusions 1102 may be seen, as well as the exterior camera opening 1202. In alternate embodiments, the protrusions 1102 may have a different size, shape, or thickness than that shown in FIG. 13. The exterior case may also include an inner surface 1302and one or more side walls (such as side walls 2102 as shown in FIG. 21 below) extending form the inner surface 1302.

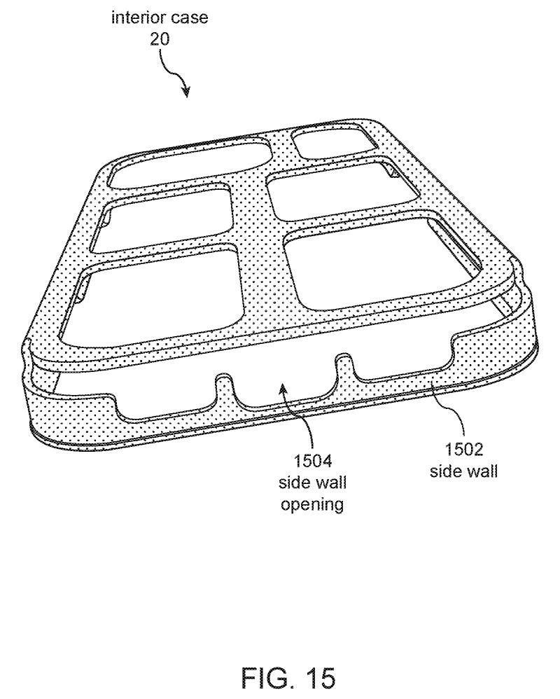

FIG. 14 illustrates a back left perspective view of an interior case 20, according to some embodiments. Shown in FIG. 14 is an interior camera opening 1404 for aligning any present component of a computing device, such as a camera, such that it is exposed to and able to interact with an exterior of the interior case 20. Also seen in FIG. 14 are five openings 1402, sized, positioned, and in a quantity for aligning and coupling with the protrusions 1102 of the exterior case 30. The interior case may also include a front side having an inner surface 1406, and one or more side walls 1502 extending from the front side. In some embodiments, the side walls 1502 of the interior case 20 may correspond with the side walls 2102 of the exterior case, so as to enable the interior case 20 to be disposed and/or nestled within the exterior case 30. The side walls 1502, 2102 of the interior case 20 and exterior case 30 may include one or more openings (e.g., side wall openings 1504, 1904, 2104, and 2106 as shown in FIGS. 15, 19, and 21 below) that are aligned with each other, thereby providing access to one or more components and/or functionalities disposed along a side portion 702 of a computing device (e.g., volume button, power button, ringer/silent mode button, etc.).

In alternate embodiments, any number of openings 1402 may be present in the interior case 20, from as few as zero openings to as many openings as may reasonably fit on the interior case 20. In some embodiments, such as the one shown in FIG. 14, it may be desirable to match the number of openings 1402 of the interior case 20 to the number of protrusions 1102 of the exterior case 30. In other embodiments, it may be desirable to locate the openings 1402 and size the openings 1402 in such a way as to facilitate placement and exertion of pressure onto a present screen protector. In such embodiments, some openings 1402 may be located and sized to align with and couple to the protrusions 1102 of the exterior case 30, while other openings are present only to facilitate such placement and exertion of pressure onto a present screen protector.

FIG. 15 illustrates a bottom front perspective view of an interior case 20, according to some embodiments. As shown, the interior case 20 includes a side wall 1502. The side wall 1502 wraps around the perimeter of the interior case 20, extending from a front side of the interior case 20. In alternate embodiments, the side wall 1502 may be located at one extreme of the interior case 20, may wrap around a partial perimeter of the interior case 20, or may be located, piecemeal, in various locations about the perimeter of the interior case 20.

Also seen in FIG. 15 is an opening in the side wall 1502 – a side wall opening 1504 (which may be located along a base portion of the interior case 20). This side wall opening 1504 extends about a distance of the side wall 1502. As shown, the side wall opening 1504 may extend the entire distance of one of the length or width of the side wall 1502. This may facilitate the removal of an object that is slightly smaller in this dimension than the interior case 20, such as a present screen protector or a dust removal film, from the inside of the interior case 20. In alternate embodiments, where such a present screen protector or dust removal film is smaller than the interior dimensions of the interior case 20, such as embodiments where the screen protector is intended to be offset from a present computing device, the side wall opening 1504 may be smaller than the length or width of the side wall 1502 on which it is present.

Also seen in FIG. 15 are various geometrical variances in the side wall opening 1504 – small, partially rounded rectangular dips. These features may permit components, such as charging cables, headphones, etc. to be attached to a present computing device while the interior case 20 is located on a second side of the computing device.

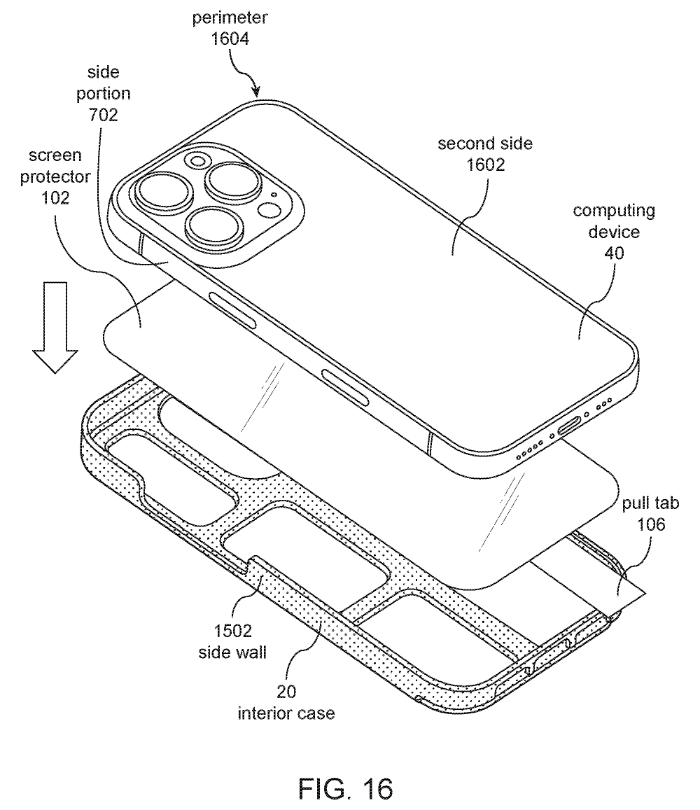

FIG. 16 illustrates an exploded perspective view of a screen protector and a case being coupled to a computing device, according to some embodiments. The case may correspond to an interior case 20, as described herein. The coupling between the case 20 and the computing device 40 may also correspond to a first arrangement coupling of the case 20 and the computing device 40.

The screen protector 102 and/or the computing device 40 may be placed at least partially within the interior case 20. For example, the screen protector 102 and/or computing device 40 may be placed within an interior space within the interior case 20, the interior space being defined by inner surface 1406 and the side walls 1502. The screen protector 102 may be disposed between the computing device 40 and the inner surface of the interior case 20, wherein the screen protector 102 may be disposed across and/or may couple with the inner surface 1406 of the interior case 20.

In some embodiments, the computing device 40 may have dimensions aligning with the interior space defined by the side walls 1502 of the computing device 40. For example, the computing device 40 may include one or more side portions 702 that correspond to the one or more side walls 1502 of the interior case 20. Accordingly, the inner surface 1406 and side walls 1502 of the interior case 20 help position the screen protector 102 with respect to a first side of the computing device, that is also aligned by the inner surface 1406 and side walls 1502 of the interior case 20.

The interior case 20 may also include one or more holding features (not shown). The one or more holding features may be similar to protruding portion 204 from FIG. 3, and may be located along a side wall 1502 of the interior case 20. The one or more holding features may be configured to couple with the computing device inserted at least partially within (as described herein) the interior case 20, so as to help hold said computing device 40 at least partially within the interior case 20, such that the computing device stays in place or substantially stays in place during application of the screen protector 102 to the computing device (e.g., a screen or first side of the computing device).

In some embodiments, the interior case 20 includes one or more adhesive patches. The one or more adhesive patches may be disposed on the inner surface of the interior case 20. The one or more adhesive patches may allow the screen protector 102 to adhere to the interior case 20 such that the screen protector 102 stays in place during application to the computing device (e.g., a first side of the computing device, which may be a screen).

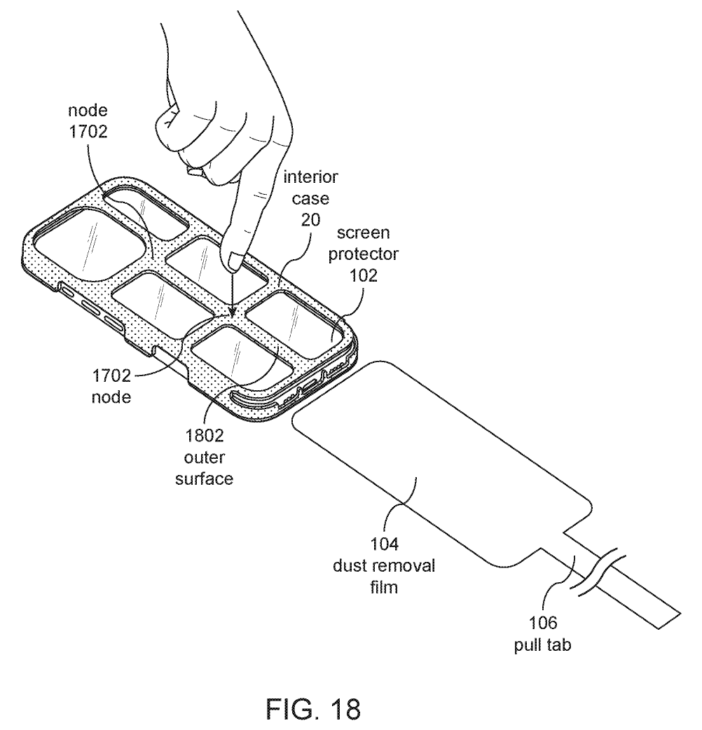

In some embodiments, the screen protector 102 is removably coupled with a dust removal film 104 (see. FIGS. 17-18 for example). For example, the dust removal film 104 may be removably adhered to, removably affixed to, or otherwise removably attached to the screen protector 102. According to some embodiments, when the screen protector 102 is placed within the interior case 20 (as described herein), the dust removal film 104 may be located on a side of the screen protector 102 opposite the side of the screen protector 102 that is facing and/or adjacent to the inner surface 1406 of the interior case 20. Alternatively, the dust removal film 104 may be located on the side of the screen protector 102 that is facing and/or adjacent to the inner surface 1406 of the interior case 20, when the screen protector 102 is placed within the interior case 20 (as described herein).

The dust removal film 104 may be the same size and/or shape as the screen protector 102. In some embodiments, the dust removal film 104 covers an entire side of the screen protector 102. In some embodiments, the dust removal film 104 may prevent fingerprints or other debris from being placed on the screen protector from the outside before and during placement of the screen protector. In the case of the dust removal film facing the first surface of the computing device, the dust removal film may prevent any particulate from forming along any adhesive or other surface on the screen protector prior to affixing the screen protector to the first surface of the computing device. In such instances, the dust removal film may further include a material or tackiness in order to pick up any preexisting debris or adhesive, such as that from a previous screen protector that has been removed.

In some embodiments, the dust removal film 104 is coupled to a pull tab 106. The pull tab 106 may extend from the dust removal film 104. The dust removal film 104 may be disposed on a first side of the screen protector 102, wherein the pull tab 106 extends from one end of the dust removal film 104, wraps around the screen protector 102, and extends along and/or across a second side (longitudinal or lateral) of the screen protector 102 opposite the first side of the screen protector 102. In other embodiments, the pull tab 106 extends along and/or across (longitudinal or lateral) the dust removal film 104 when coupled to the screen protector 102.

For example, the dust removal film 104 may include a pull tab 106 that extends from a “top” side of the dust removal film 104 and extends back upon the dust removal film 104, elongated such that the pull tab 106 is configured to extend past a “bottom” of the dust removal film 104, and in some cases, through a side wall opening 1504 of the interior case 20 (when the dust removal film 104 is disposed at least partially within the interior case 20).

The pull tab 106 may vary in length, such as being longer than a length of the screen protector 102, being about the same length of the screen protector 102, or less than a length of the screen protector 102.

FIG. 17 illustrates a profile view of a dust removal film being removed from a case, according to some embodiments. The pull tab 106 may extend through an opening (such as side wall opening 1504 as seen in FIG. 15 above) in a side wall of the interior case 20 when the screen protector 102 is placed within the interior case 20. Accordingly, the dust removal film 104 may be pulled through the opening via the pull tab 106. According to some embodiments, the dust removal film 104 is pulled from between the screen protector 102 and the first side of the computing device (e.g., mobile phone screen 402).

For example, once the screen protector 102 has been placed on the first side of the computing device, such as mobile phone screen 402, and while the screen protector 102 is aligned about said first side of the computing device via the interior case 20 (as described herein), the pull tab 106 may be pulled through a slot in the interior case (e.g., side wall opening 1504) in order to remove the dust removal film 104 and begin adhesion of the screen protector 102 to the computing device (see for example, FIG. 17).

In other embodiments, the dust removal film 104 is pulled from between the screen protector 102 and the inner surface 1406 of the interior case 20. In yet other embodiments, the dust removal film is pulled from between the screen protector 102 and the first side of the computing device 40, but wraps around the screen protector 102, and is then pulled between the screen protector 102 and the inner surface 1406 of the interior case 20. The dust removal film 104 may wrap around an end of the screen protector 102 that is disposed about an end of the interior case 20 opposite to the end where the opening is located.

In additional embodiments, the screen protector 102 is removably coupled with a second dust removal film (not shown) disposed on a second side of the screen protector 102, opposite to the side where the dust removal film 104 is disposed, and where the second side of the screen protector 102 may face away from the computing device onto which the screen protector 102 is being placed. This second dust removal film may act as a protective device to prevent abrasions from occurring on the screen protector 102 prior to placement on the computing device. This second dust removal film may be removed prior to inserting the screen protector 102 within the interior case 20 and/or coupling to the computing device.

FIG. 18 illustrates a profile view of a pressure being exerted on a case, according to some embodiments. This figure shows a user’s press of the outer surface 1802 of the interior case 20, after the dust removal film 104 was removed from within the interior case 20. The user press may be at any portion of the outer surface 1802 of the interior case 20. Moreover, the interior case 20 may include any form of an outer surface, such as a solid continuous surface, any number of grids having any number of nodes (see 1702 for example), an outer surface having one or more curves or other shapes, etc.

In some embodiments, the user’s press on the outer surface 1802 applies a pressure, which may thereby apply a pressure to the screen protector 102 towards the computing device. Applying a pressure on the outer surface may help adhere the screen protector 102 to the computing device (e.g., first side of the computing device). Alternatively or additionally, applying a pressure on the outer surface may help remove and/or reduce the presence of air bubbles disposed between the screen protector and the first side of the computing device (e.g., screen). In one example, a user may slide a finger or other object along the outer surface 1802 of the interior case 20 so as to help the screen protector 102 adhere to the computing device, and/or reduce the presence of air bubbles located therebetween.

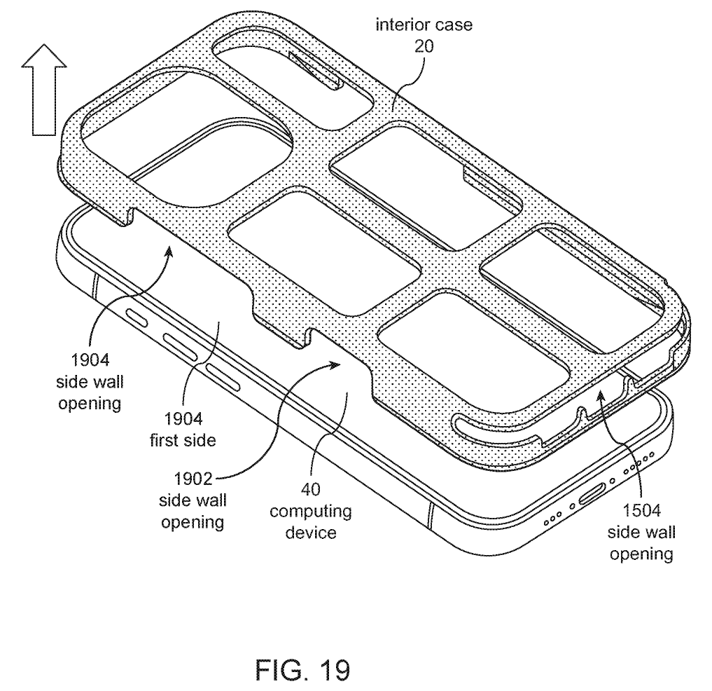

FIG. 19 illustrates a case being removed from a computing device, according to some embodiments. After a screen protector 102 has been placed on the first side 1902 of a computing device 40, a user may want to remove the interior case 20 from this first side 1902 of the computing device 40. As is also seen in FIG. 19, the interior case 20 may include additional side wall openings 1904 in the side wall 1502 (e.g., along a longitudinal portion of the interior case 20). The side wall openings 1904 may extend all the way to the bottom (in this perspective) of the side wall 1502. These side wall openings 1904 may be located and sized to permit a user to access any buttons or controls that may reside on a side (e.g., side portion 702) of the computing device 40 while the interior case 20 is in place on the first side 1902 of the computing device 40.

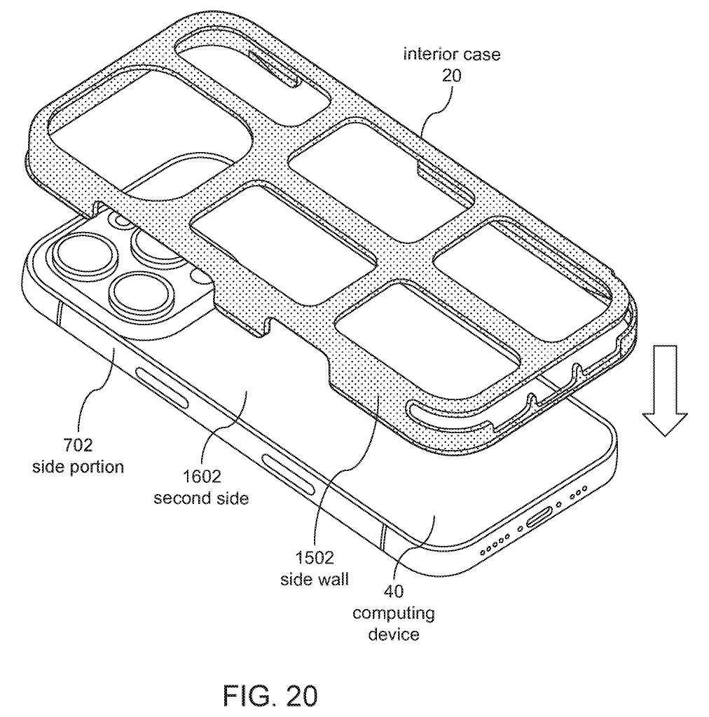

FIG. 20 illustrates a case being placed onto another side of a computing device 40, according to some embodiments. Once the interior case 20 has been removed from the first side 1902 of the computing device 40, it may be placed on the second side 1602 of the computing device 40. Similar to FIG. 19 above, the side wall 1502 may include openings (e.g., 1904), permitting access to any buttons or controls that exist on the side of the computing device 40. In this way, the interior case 20 may function as a protective case for the computing device 40, preventing or limiting damage to the computing device 40 (e.g., in instances of injury, such as through dropping of the computing device 40).

In both FIGS. 19 and 20, the side wall openings 1904 in the sidewall 1502 are sized and located such that any present buttons or controls may be accessed when the interior case 20 is placed on the first side 1902 or second side 1602 of the computing device 40. In alternate embodiments, there may be no openings along this side wall, openings for only certain buttons or controls of the computing device, or openings that extend further than needed only to access these buttons or controls. Additionally or alternatively, the depth of the openings may increase, exposing more of the computing device, or decrease, exposing less of both the computing device and the associated buttons or controls.

Once the interior case 20 is placed on the computing device 40, such as for example about the second side 1602 of the computing device, the protective case may be considered complete. As described above, the interior case 20 may include a rigid material 1004, a flexible material 1006, or a combination of both, as desired. Additionally, or alternatively, the interior case 20 may include shock-absorbing characteristics, which may facilitate the prevention of injury to the computing device 40 in instances such as a dropping of the computing device 40.

FIG. 21 illustrates a second case being placed onto a computing device, according to some embodiments. As seen in FIG. 21, an exterior case 30 is being placed about the interior case 20, which is already shown coupled to the computing device 40. Alternatively, the exterior case 30 may be first coupled with the interior case 20, prior to either or both of the interior case 20 and exterior case 30 are coupled to and/or placed over a second side of the computing device. With respect to FIG. 21, while not labeled, the indentations 1204 of the exterior case 30 are seen as at least partially aligned with the openings 1402 of the interior case 20. In this embodiment, but not all embodiments, this indicates that the opposite side of the exterior case 30 includes protrusions 1102 which also at least partially aligned with the openings 1402 of the interior case 20. In this way, once the exterior case 30 has been placed over the interior case 20, the protrusions 1102 may be coupled with the openings 1402, thereby coupling the exterior case 30 to the interior case 20. Alternatively or additionally, there are no, fewer, or more, or non-aligned protrusions, and the coupling of the exterior case 30 to either of the interior case 20 or the computing device 40 may occur from a friction fit between the side walls of such components.

As is seen in FIG. 21 are openings of the side wall 2102 (side wall openings 2104) of a base of the exterior case 30, as well as the side wall 2102 along a longitudinal portion of the exterior case 30 (side wall openings 2106). Similar to the interior case 20, the side wall 2102 along the longitudinal portion of the exterior case 30 may include side wall openings 2106 that extend to the bottom (in this perspective) of the side wall 2102. These side wall openings 2106 may be located and sized to permit a user to access any buttons or controls that may reside on a side of the computing device 40 while the exterior case 30 is in place about the interior case 20 and the computing device 40.

In alternate embodiments, there may be no openings along this side wall, openings for only certain buttons or controls of the computing device, or openings that extend further than needed only to access these buttons or controls. Additionally or alternatively, the depth of the openings may increase, exposing more of the computing device, or decrease, exposing less of both the computing device and the associated buttons or controls. Additionally, the openings in the side of the side wall of the exterior case 30 need not align with, or match in number or size, the openings in the side wall 1502 of the interior case 20.

The side wall openings 2104 of the side wall 2102 of the exterior case 30 (e.g., along a base portion of the exterior case 30), as seen in FIG. 21, align with the various geometrical variances in the side wall opening 1504 (as described above in FIG. 15). These side wall openings 2104 may permit components, such as charging cables, headphones, etc. to be attached to a present computing device while the exterior case 30 is located about the interior case 20 and the computing device 40.

In alternate embodiments, the side wall openings 2104 of the side wall 2102 of the exterior case 30 may differ in number, size, location, or alignment from the geometrical variances in the side wall opening 1504 of the interior case 20. Additionally or alternatively, the openings in the bottom of the side wall of the exterior case 30 may extend to the bottom (in this perspective) of the side wall 2102.

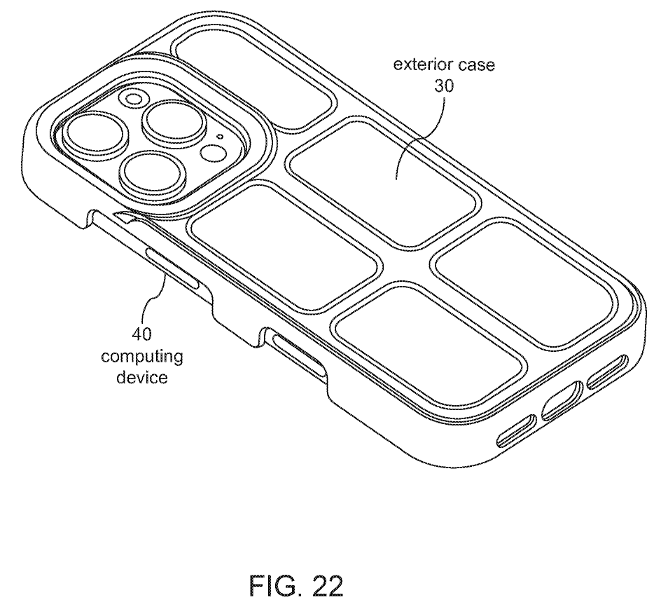

FIG. 22 illustrates a computing device with multiple cases placed onto it, according to some embodiments. In this figure, it is shown that the exterior case 30 has been fully placed onto the interior case 20, thus obscuring it from view. Both the exterior case 30 and the interior case 20 are coupled to the second side 1602 of the computing device 40. The side walls 1502, 2102 of the interior case 20 and exterior case 30 respectively are also coupled with and/or aligned with the side portions 702 of the computing device. Also shown in this figure are the openings in the side and bottom of the side wall of the exterior case 30 permitting access to the various buttons and controls, as well as any present ports for receiving components such as charging cables, headphones, etc.

As described above, the exterior case 30 may include a rigid material 1004, a flexible material 1006, or a combination of both, as desired. Additionally, or alternatively, the exterior case 30 may include shock-absorbing characteristics, which may facilitate the prevention of injury to the computing device 40 in instances such as a dropping of the computing device 40. Two bodies (e.g., interior case 20 and exterior case 30) encapsulating one another with a small gap between them may amplify any present shock-absorbing characteristics present in either of the cases, thus further preventing or limiting damage to the underlying computing device 40.

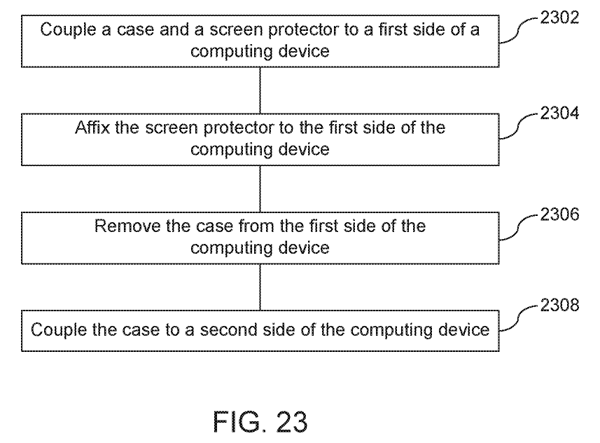

FIG. 23 illustrates a flow chart depicting a method of coupling a case and a screen protector to a computing device, according to some embodiments. In some embodiments, the method includes coupling a case and a screen protector to a first side of a computing device (at step 2302). The first side of the computing device may be the side that includes a screen, wherein the screen protector is intended to prevent or limit damage that may be done to the screen. The case may be able to hold the screen protector in place, such that the screen protector is between the case and the computing device. The case may help in aligning the screen protector with the case (e.g., aligning the screen protector with at least a portion of the perimeter of the first side of the computing device). According to some embodiments, the method includes affixing the screen protector to the first side of the computing device (at step 2304). The screen protector may include some kind of light adhesive, which permits the screen protector to stay in place with respect to the computing device.

The method may include removing the case from the first side of the computing device (at step 2306). Once the screen protector is adhered to the computing device, the case may be removed while the screen protector stays in place. In some embodiments, the method includes coupling the case to a second side of the computing device (at step 2308). With the screen protector now affixed to the computing device, the case may become a protective casing for the computing device, residing on the side opposite the screen protector so that a screen underneath the screen protector may still be fully viewed and interacted with.

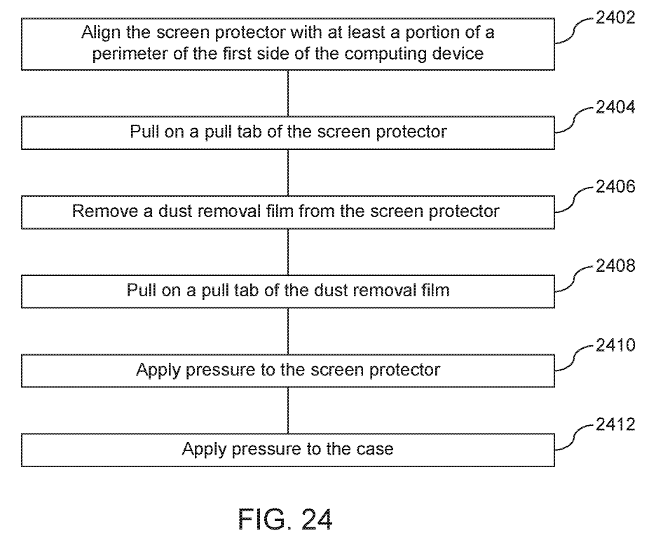

FIG. 24 illustrates a flow chart depicting a method of aligning and adhering a screen protector to a computing device, according to some embodiments. According to some embodiments, the method includes aligning the screen protector with at least a portion of a perimeter of the first side of the computing device (at step 2402). The screen protector may be partially offset from the first side of the computing device, such that it does not completely cover the entire surface of the first side of the computing device. In other embodiments, the screen protector may cover the entire first side of the computing device. The method may optionally include pulling on a tab optionally coupled with the screen protector (at step 2404).

The screen protector may be properly placed, and/or stretched to fit the proportions necessary for the first side of the computing device. This stretching motion may also cause the screen protector to begin the process of adhering to the computing device. The pull tab may be removable from the screen protector after placement.

In some embodiments, the method includes removing a dust removal film from the screen protector (at step 2406). The screen protector may include a dust removal film on either the surface facing the case (when the case is located on the first side of the computing device), or the surface facing the first side of the computing device. In the instance of the dust removal film facing the case, the dust removal film may prevent fingerprints or other debris from being placed on the screen protector from the outside before and during placement of the screen protector. In the case of the dust removal film facing the first surface of the computing device, the dust removal film may prevent any particulate from forming along any adhesive on the screen protector prior to affixing the screen protector to the first surface of the computing device. In such instances, the dust removal film may further include a material or tackiness in order to pick up any preexisting debris or adhesive, such as that from a previous screen protector that has been removed.

According to some embodiments, the method may include pulling on a pull tab of the dust removal film (at step 2408). This pull tab may be located nearest the end of the dust removal film that it is being pulled from, or on the side opposing nearest the end it is being pulled from. In the instance of the pull tab being located on the side opposing nearest the end it is being pulled from, the dust removal film may make a U-shaped turn, and come back upon itself to egress the case. In such instances, any material or tackiness, as mentioned in the preceding paragraph, may be applied to the surface of the dust removal film that would now be facing the first surface of the computing device.

The method may include applying pressure to the screen protector (at step 2410). Application of pressure to the screen protector may increase the efficacy of adhesion of the screen protector to the first surface of the computing device, as well as releasing/pushing out any air bubbles that may have become trapped between the screen protector and the first surface of the computing device. In some embodiments, the method includes applying pressure to the case (at step 2412). When the screen protector is located between the case and the first surface of the computing device, pressure on the case itself may be subsequently applied from the case to the screen protector, which once again may increase the efficacy of adhesion of the screen protector to the first surface of the computing device, as well as releasing/pushing out any air bubbled that may have become trapped between the screen protector and the first surface of the computing device.

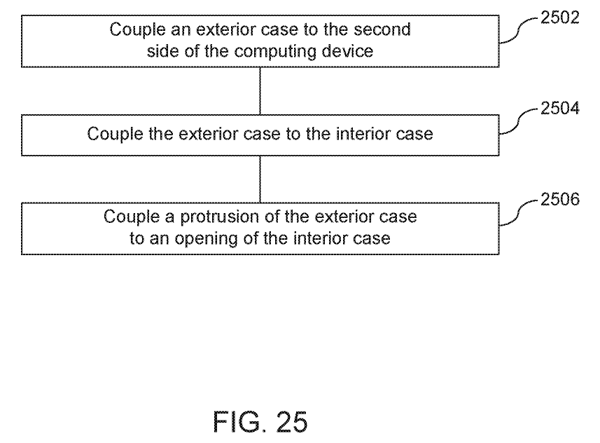

FIG. 25 illustrates a method coupling an additional case to a computing device that is partially covered or enclosed by a first case, according to some embodiments. According to some embodiments, the method includes coupling an exterior case to the second side of the computing device (at step 2502). As seen in FIG. 2308 in FIG. 23 above), an interior case may already be coupled to the second side of a computing device (e.g., in a second arrangement as described herein), and a subsequent, exterior case may be placed surrounding the interior case to add additional protection. Two bodies encapsulating one another with a small gap between them may amplify any present shock-absorbing characteristics present in either of the cases.

The method may include coupling the exterior case to the interior case (at step 2504). Beyond coupling the exterior case to the second surface of the computing device, the exterior case may further couple directly to the interior case. In some embodiments, the method includes coupling a protrusion of the exterior case to an opening of the interior case (at step 2506). The exterior case may include features, such as one or more protrusions, that are aligned with and capable of coupling to features of the interior case, such as one or more openings. The exterior case may first couple with an interior case, prior to both cases being disposed about and/or coupled with the second side of the computing device.

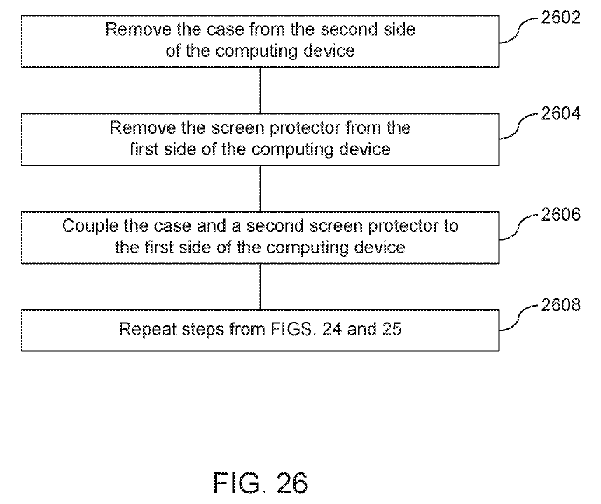

FIG. 26 illustrates a method of replacing a screen protector, according to some embodiments. According to some embodiments, the method includes removing the case from the second side of the computing device (at step 2602). A user may want to remove the case from the computing device for a number of reasons, including but not limited to changing the case for another one, or reapplication of a screen protector. The method may include removing the screen protector from the first side of the computing device (at step 2604). A screen protector may become damaged or hazy over a period of use, and it may be desirable at such a time to replace the screen protector. In order to do so, a user may want to first remove the original screen protector.

In some embodiments, the method includes coupling the case and a second screen protector to the first side of the computing device (at step 2606). In applying a subsequent, or second, screen protector to the computing device, a user may be capable of using the same case as seen in the method of FIG. 23. According to some embodiments, the method includes repeating the steps from FIGS. 24 and 25 (at step 2608). The case may interchangeably used as a screen protector placement system (or jig), as well as a protective case for the computing device. The case is still capable of coupling to an exterior case in embodiments including an exterior case, after repeated uses as a screen protector placement system.

Included in the present disclosure is a system, including a screen protector configured to be applied to a first side of a computing device. In some embodiments, the system includes a case configured to be coupled to the computing device in two arrangements. According to some embodiments, in a first arrangement the case is configured to be disposed over the first side of the computing device such that the screen protector is located between an inner surface of the case and the first side of the computing device, the case configured to align the screen protector with at least a portion of a perimeter of the first side of the computing device. In a second arrangement, the case may be configured to be disposed over a second side of the computing device opposite the first side of the computing device.

In some embodiments, in the first arrangement the case is configured to enable the screen protector to adhere to the first side of the computing device. According to some embodiments, the system further includes a pull tab coupled to the screen protector configured to enable the screen protector to adhere to the first side of the computing device.

The system may further include a dust removal film coupled to a surface of the screen protector. In some embodiments, the dust removal film is coupled to a surface of the screen protector facing the first side of the computing device, such that the dust removal film is disposed between the screen protector and the first side of the computing device. According to some embodiments, the dust removal film includes a pull tab configured to extend beyond the first side of the computing device. The pull tab may be configured to remove the dust removal film from between the screen protector and the computing device.

In some embodiments, the dust removal film is coupled to a surface of the screen protector facing the inner surface of the case, such that the dust removal film is disposed between the screen protector and the inner surface of the case. According to some embodiments, the dust removal film includes a pull tab configured to extend beyond the first side of the computing device. The pull tab may be configured to remove the dust removal film from between the screen protector and the inner surface of the case.

In some embodiments, a surface perimeter of the screen protector is configured to align with the perimeter of the first side of the computing device. According to some embodiments, a side perimeter of the screen protector is configured to align with a side perimeter of the first side of the computing device. A side perimeter of the screen protector may be configured to be offset from a side perimeter of the first side of the computing device. In some embodiments, the offset is between zero and one millimeter.

According to some embodiments, the case includes a side wall extending from the inner surface of the case. The side wall of the case may be configured to align with and couple to a side wall of the computing device. In some embodiments, the side wall of the computing device is configured to correspond with the side wall of the case. According to some embodiments, the side wall includes a protruding portion to removably affix the case to the computing device in an arrangement selected from the group consisting of the first arrangement, the second arrangement, and combinations thereof. The side wall may include an opening sized to pass the screen protector therethrough. In some embodiments, the system further includes a dust removal film coupled to a surface of the screen protector, and the side wall includes an opening configured to pass the dust removal film therethrough.

According to some embodiments, an outer side of the case is configured to receive a pressure through an external source and thereby contact the screen protector when in the first arrangement, thereby applying the pressure to the screen protector. The pressure may be configured to remove an air bubble from between the screen protector and the first side of the computing device.

In some embodiments, the case is an interior case, and the system further includes an exterior case configured to couple to the interior case in the second arrangement. According to some embodiments, the interior case includes an opening, and the exterior case includes a protrusion that aligns with the opening, the protrusion facing the interior case. The exterior case may include an indentation that aligns with the protrusion, the indentation located on an opposite side of the exterior case from the protrusion. In some embodiments, the interior case includes an interior camera opening, and the exterior case includes an exterior camera opening that substantially aligns with the interior camera opening, and each of the interior camera opening and the exterior camera opening substantially aligns with a camera of the computing device.

According to some embodiments, the interior case includes a rigid material, and the exterior case includes a flexible material. The exterior case may include shock-absorbing properties. In some embodiments, the interior case includes shock-absorbing properties.

The case may include a plurality of openings and a node between each of the plurality of openings. In some embodiments, the node is configured to receive a pressure through an external source and thereby contact the screen protector when in the first arrangement, thereby applying the pressure to the screen protector.

According to some embodiments, the case is an interior case, and the system further includes an exterior case configured to couple to the interior case in the second arrangement. The exterior case may include a plurality of protrusions that align with the plurality of openings, the plurality of protrusions facing the interior case. In some embodiments, the exterior case includes a plurality of indentations that align with the plurality of protrusions, the plurality of indentations located on an opposite side of the exterior case from the plurality of protrusions.

According to some embodiments, the case includes shock-absorbing properties. The case may include an adhesive patch on an inner side. In some embodiments, the adhesive patch is configured to adhere to the screen protector thereby maintaining a position of the screen protector with respect to the first side of the computing device.

Also included in the present disclosure is a method, including coupling a case and a screen protector to a first side of a computing device such that the screen protector is disposed between the case and the first side of the computing device. In some embodiments, the method includes affixing the screen protector to the first side of the computing device. According to some embodiments, the method includes removing the case from the first side of the computing device. The method may include coupling the case to a second side of the computing device opposite the first side of the computing device.

In some embodiments, coupling the case and the screen protector to the first side of the computing device includes aligning the screen protector with at least a portion of a perimeter of the first side of the computing device. According to some embodiments, affixing the screen protector to the first side of the computing device includes pulling on a pull tab of the screen protector.

Affixing the screen protector to the first side of the computing device may include removing a dust removal film from the screen protector. In some embodiments, removing the dust removal film from the screen protector includes pulling on a pull tab of the dust removal film.

According to some embodiments, the method further includes applying pressure to the screen protector. Applying pressure to the screen protector may be configured to remove an air bubble between the screen protector and the first side of the computing device. In some embodiments, applying pressure to the screen protector includes applying pressure to the case, thereby imparting the pressure to the screen protector.

According to some embodiments, the case is an interior case, and the method further includes coupling an exterior case to the second side of the computing device such that the interior case is located between the exterior case and the second side of the computing device. The method may further include coupling the exterior case to the interior case. In some embodiments, the interior case includes an opening and the exterior case includes a protrusion, and coupling the exterior case to the interior case includes coupling the protrusion to the opening.

According to some embodiments, the method further includes removing the case from the second side of the computing device. The method may further include removing the screen protector from the first side of the computing device.

In some embodiments, the screen protector is a first screen protector, and the method further includes coupling the case and a second screen protector to the first side of the computing device. According to some embodiments, coupling the case and the second screen protector to the first side of the computing device includes aligning the second screen protector with at least a portion of a perimeter of the first side of the computing device. Affixing the second screen protector to the first side of the computing device may include pulling on a pull tab of the second screen protector.

In some embodiments, affixing the second screen protector to the first side of the computing device includes removing a dust removal film from the second screen protector. According to some embodiments, removing the dust removal film from the second screen protector includes pulling on a pull tab of the dust removal film.

The method may further include applying pressure to the second screen protector. In some embodiments, applying pressure to the second screen protector is configured to remove an air bubble between the second screen protector and the first side of the computing device. According to some embodiments, applying pressure to the second screen protector includes applying pressure to the case, thereby imparting the pressure to the second screen protector.

The case may be an interior case, and the method may further include coupling an exterior case to the second side of the computing device such that the interior case is located between the exterior case and the second side of the computing device. In some embodiments, the method further includes coupling the exterior case to the interior case. According to some embodiments, the interior case includes an opening and the exterior case includes a protrusion, and coupling the exterior case to the interior case includes coupling the protrusion to the opening.

Also included in the present disclosure is a system, including an interior case configured to be coupled to a computing device in two arrangements. In some embodiments, in a first arrangement the interior case is configured to be disposed over a first side of the computing device. According to some embodiments, in a second arrangement the interior case is configured to be disposed over a second side of the computing device opposite the first side of the computing device. The system may include an exterior case configured to couple to the interior case in the second arrangement.

In some embodiments, the interior case includes an opening, and the exterior case includes a protrusion that aligns with the opening, the protrusion facing the interior case. According to some embodiments, the exterior case includes an indentation that aligns with the protrusion, the indentation located on an opposite side of the exterior case from the protrusion. The interior case may include an interior camera opening, and the exterior case may include an exterior camera opening that substantially aligns with the interior camera opening, and each of the interior camera opening and the exterior camera opening may substantially align with a camera of the computing device.

In some embodiments, the interior case includes a rigid material, and the exterior case includes a flexible material. According to some embodiments, the exterior case includes shock-absorbing properties. The interior case may include shock-absorbing properties.

In some embodiments, the system further includes a screen protector configured to be applied to the first side of the computing device, the screen protector located between an inner surface of the interior case and the first side of the computing device, the interior case configured to align the screen protector with at least a portion of a perimeter of the first side of the computing device. According to some embodiments, in the first arrangement the interior case is configured to enable the screen protector to adhere to the first side of the computing device. The system may further include a pull tab coupled to the screen protector configured to enable the screen protector to adhere to the first side of the computing device.

In some embodiments, the system further includes a dust removal film coupled to a surface of the screen protector. According to some embodiments, the dust removal film is coupled to a surface of the screen protector facing the first side of the computing device, such that the dust removal film is disposed between the screen protector and the first side of the computing device. The dust removal film may include a pull tab configured to extend beyond the first side of the computing device. In some embodiments, the pull tab is configured to remove the dust removal film from between the screen protector and the computing device.

According to some embodiments, the dust removal film is coupled to a surface of the screen protector facing the inner surface of the interior case, such that the dust removal film is disposed between the screen protector and the inner surface of the interior case. The dust removal film may include a pull tab configured to extend beyond the first side of the computing device. In some embodiments, the pull tab is configured to remove the dust removal film from between the screen protector and the inner surface of the interior case.

According to some embodiments, a surface perimeter of the screen protector is configured to align with the perimeter of the first side of the computing device. A side perimeter of the screen protector may be configured to align with a side perimeter of the first side of the computing device. In some embodiments, a side perimeter of the screen protector is configured to be offset from a side perimeter of the first side of the computing device. According to some embodiments, the offset is between zero and one millimeter.

The interior case may include a side wall extending from the inner surface of the interior case. In some embodiments, the side wall of the interior case is configured to align with and couple to a side wall of the computing device. According to some embodiments, the side wall of the computing device is configured to correspond with the side wall of the interior case.

The side wall may include a protruding portion to removably affix the interior case to the computing device in an arrangement selected from the group consisting of the first arrangement, the second arrangement, and combinations thereof. In some embodiments, the side wall includes an opening sized to pass the screen protector therethrough. According to some embodiments, the system further includes a dust removal film coupled to a surface of the screen protector, the side wall including an opening configured to pass the dust removal film therethrough.

An outer side of the interior case may be configured to receive a pressure through an external source and thereby contact the screen protector when in the first arrangement, thereby applying the pressure to the screen protector. In some embodiments, the pressure is configured to remove an air bubble from between the screen protector and the first side of the computing device.

According to some embodiments, the interior case includes a plurality of openings and a node between each of the plurality of openings. The node may be configured to receive a pressure through an external source and thereby contact the screen protector when in the first arrangement, thereby applying the pressure to the screen protector.

In some embodiments, the interior case includes an adhesive patch on an inner side. According to some embodiments, the adhesive patch is configured to adhere to the screen protector thereby maintaining a position of the screen protector with respect to the first side of the computing device.

Also included in the present disclosure is a system, including a screen protector configured to be applied to a first side of a computing device. In some embodiments, the system includes an interior case configured to be coupled to the computing device in two arrangements. According to some embodiments, in a first arrangement, the interior case is configured to be disposed over the first side of the computing device such that the screen protector is located between an inner surface of the interior case and the first side of the computing device, the interior case configured to align the screen protector with at least a portion of a perimeter of the first side of the computing device. In a second arrangement, the interior case may be configured to be disposed over a second side of the computing device opposite the first side of the computing device. In some embodiments, the system includes an exterior case configured to couple to the interior case in the second arrangement.

According to some embodiments, the interior case includes an opening, and the exterior case includes a protrusion that aligns with the opening, the protrusion facing the interior case. The exterior case may include an indentation that aligns with the protrusion, the indentation located on an opposite side of the exterior case from the protrusion. In some embodiments, the interior case includes an interior camera opening, and the exterior case includes an exterior camera opening that substantially aligns with the interior camera opening, and each of the interior camera opening and the exterior camera opening substantially align with a camera of the computing device.

According to some embodiments, the interior case includes a rigid material, and the exterior case includes a flexible material. The exterior case may include shock-absorbing properties. In some embodiments, the interior case includes shock-absorbing properties.

According to some embodiments, in the first arrangement, the interior case is configured to enable the screen protector to adhere to the first side of the computing device. The system may further include a pull tab coupled to the screen protector configured to enable the screen protector to adhere to the first side of the computing device.

In some embodiments, the system further includes a dust removal film coupled to a surface of the screen protector. According to some embodiments, the dust removal film is coupled to a surface of the screen protector facing the first side of the computing device, such that the dust removal film is disposed between the screen protector and the first side of the computing device. The dust removal film may include a pull tab configured to extend beyond the first side of the computing device. In some embodiments, the pull tab is configured to remove the dust removal film from between the screen protector and the computing device.

According to some embodiments, the dust removal film is coupled to a surface of the screen protector facing the inner surface of the interior case, such that the dust removal film is disposed between the screen protector and the inner surface of the interior case. The dust removal film may include a pull tab configured to extend beyond the first side of the computing device. In some embodiments, the pull tab is configured to remove the dust removal film from between the screen protector and the inner surface of the interior case.

According to some embodiments, a surface perimeter of the screen protector is configured to align with the perimeter of the first side of the computing device. A side perimeter of the screen protector may be configured to align with a side perimeter of the first side of the computing device.

In some embodiments, a side perimeter of the screen protector is configured to be offset from a side perimeter of the first side of the computing device. According to some embodiments, the offset is between zero and one millimeter.

The interior case may include a side wall extending from the inner surface of the interior case. In some embodiments, the side wall of the interior case is configured to align with and couple to a side wall of the computing device. According to some embodiments, the side wall of the computing device is configured to correspond with the side wall of the interior case.

The side wall may include a protruding portion to removably affix the interior case to the computing device in an arrangement selected from the group consisting of the first arrangement, the second arrangement, and combinations thereof. In some embodiments, the side wall includes an opening sized to pass the screen protector therethrough. According to some embodiments, the system further includes a dust removal film coupled to a surface of the screen protector, the side wall including an opening configured to pass the dust removal film therethrough.

An outer side of the interior case may be configured to receive a pressure through an external source and thereby contact the screen protector when in the first arrangement, thereby applying the pressure to the screen protector. In some embodiments, the pressure is configured to remove an air bubble from between the screen protector and the first side of the computing device.

According to some embodiments, the interior case includes a plurality of openings and a node between each of the plurality of openings. The node may be configured to receive a pressure through an external source and thereby contact the screen protector when in the first arrangement, thereby applying the pressure to the screen protector.

In some embodiments, the interior case includes an adhesive patch on an inner side. According to some embodiments, the adhesive patch is configured to adhere to the screen protector thereby maintaining a position of the screen protector with respect to the first side of the computing device.

Some of the components listed herein use the same number from figure to figure. It should be appreciated these components use the same numbers solely for ease of reference and to facilitate comprehension for the reader. While these components may use the same numbers, differences may be present in these components as illustrated in the various figures in which they appear and as described in the specification herein.

None of the steps described herein is essential or indispensable. Any of the steps may be adjusted or modified. Other or additional steps may be used. Any portion of any of the steps, processes, structures, and/or devices disclosed or illustrated in one embodiment, flowchart, or example in this specification may be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1, and embodiments described in other sections may apply to and be combined with embodiments described within the “Topic 1” section.

To increase the clarity of various features, other features are not labeled in each figure.

The various features and processes described above may be used independently of one another or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, parallel, or some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless expressly stated otherwise, or otherwise understood within the context as used, is generally intended to convey that certain embodiments include, while other embodiments do not include, certain features, elements and/or steps. Thus, such conditional language is not generally intended to imply that features, elements, and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless expressly stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments can include A, B, and C. The term “and/or” is used to avoid unnecessary redundancy.

While certain example embodiments have been described, these embodiments have been presented by way of example only and are not intended to limit the scope of the inventions disclosed herein. Thus, nothing in the foregoing description implies that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

We claim:

1. A system, comprising:
a screen protector configured to be applied to a first side of a computing device; and
a case configured to be coupled to the computing device in two arrangements,
wherein in a first arrangement the case is configured to be disposed over the first side of the computing device such that the screen protector is located between an inner surface of the case and the first side of the computing device, the case configured to align the screen protector with at least a portion of a perimeter of the first side of the computing device, and
wherein in a second arrangement the case is configured to be disposed over a second side of the computing device opposite the first side of the computing device.

2. The system of claim 1, wherein in the first arrangement the case is configured to enable the screen protector to adhere to the first side of the computing device.

3. The system of claim 1, further comprising a dust removal film coupled to a surface of the screen protector.

4. The system of claim 3, further comprising a pull tab coupled to the dust removal film configured to remove the dust removal film and thereby enable the screen protector to adhere to the first side of the computing device.

5. The system of claim 1, wherein a surface perimeter of the screen protector is configured to align with the perimeter of the first side of the computing device.

6. The system of claim 1, wherein the case comprises a side wall extending from the inner surface of the case.

7. The system of claim 6, wherein the side wall includes a protruding portion to removably affix the case to the computing device in an arrangement selected from the group consisting of the first arrangement, the second arrangement, and combinations thereof.

8. The system of claim 6, wherein the side wall comprises an opening sized to pass the screen protector therethrough.

9. The system of claim 1, wherein an outer side of the case is configured to receive a pressure through an external source and thereby contact the screen protector when in the first arrangement, thereby applying the pressure to the screen protector.

10. The system of claim 9, wherein the pressure is configured to remove an air bubble from between the screen protector and the first side of the computing device.

11. The system of claim 1, wherein the case is an interior case, the system further comprising an exterior case configured to couple to the interior case in the second arrangement.

12. The system of claim 11, wherein the interior case comprises an opening, and wherein the exterior case comprises a protrusion that aligns with the opening, the protrusion facing the interior case.

13. The system of claim 12, wherein the exterior case comprises an indentation that aligns with the protrusion, the indentation located on an opposite side of the exterior case from the protrusion.

14. A method, comprising:
coupling a case and a screen protector to a first side of a computing device such that the screen protector is disposed between the case and the first side of the computing device;
affixing the screen protector to the first side of the computing device;
removing the case from the first side of the computing device; and
coupling the case to a second side of the computing device opposite the first side of the computing device.

15. The method of claim 14, wherein coupling the case and the screen protector to the first side of the computing device comprises aligning the screen protector with at least a portion of a perimeter of the first side of the computing device.

16. The method of claim 14, wherein affixing the screen protector to the first side of the computing device comprises removing a dust removal film from the screen protector.

17. The method of claim 16, wherein removing the dust removal film from the screen protector comprises pulling on a pull tab coupled to the dust removal film.

18. The method of claim 14, further comprising applying pressure to the screen protector.

19. The method of claim 18, wherein applying pressure to the screen protector is configured to remove an air bubble between the screen protector and the first side of the computing device.

20. The method of claim 14, wherein the case is an interior case, the method further comprising coupling an exterior case to the second side of the computing device such that the interior case is located between the exterior case and the second side of the computing device.
